(19) United States
(12) Patent Application Publication
(10) Pub. No.: US 2014/0062418 A1
(43) Pub. Date: Mar. 6, 2014

(54) SAFETY APPARATUS FOR BATTERY MODULE OF ELECTRIC VEHICLE

(71) Applicants: HYUNDAI MOTOR COMPANY, Seoul (KR); KIA MOTORS CORPORATION, Seoul (KR)

(72) Inventor: Hae Kyu Lim, Bucheon (KR)

(73) Assignees: Kia Motors Corporation, Seoul (KR); Hyundai Motor Company, Seoul (KR)

(21) Appl. No.: 13/688,582

(22) Filed: Nov. 29, 2012

(30) Foreign Application Priority Data
Sep. 6, 2012 (KR) 10-2012-0098717

(51) Int. Cl. H02J 7/00

(52) U.S. Cl. CPC H02J 7/0031
USPC 320/137

(57) ABSTRACT

Disclosed herein is a safety apparatus for a battery module of an electric vehicle preventing an entire electrode of a battery cell from fracturing due to a swelling expansive force upon overcharging, the apparatus including an end plate and a power supply unit. The end plate is disposed at ends of both sides of a battery module, includes an opening, and delivers an expansive force generated in the battery module to the exterior through the opening upon swelling. The power supply unit is disposed in the end plate and interrupts a current supplied to the battery module using the expansive force delivered through the opening.

### CROSS-REFERENCE TO RELATED APPLICATION

This application claims under 35 U.S.C. §119(a) the benefit of Korean Patent Application No. 10-2012-0098717 filed Sep. 6, 2012, the entire contents of which are incorporated herein by reference.

### BACKGROUND

(a) Technical Field

The present invention relates to a safety apparatus for a battery module of an electric vehicle. More particularly, the present invention relates to a safety apparatus, which interrupts a current without damage of a battery module when overcharging occurs.

(b) Background Art

Generally, hybrid vehicles use two or more different types of power sources efficiently combined to provide a power to the drive train. Many hybrid vehicles acquire a driving force from an internal combustion engine and an electric motor which uses battery power, which are called Hybrid Electric Vehicles (HEV).

A hybrid electric vehicle (HEV) may be equipped with a high voltage battery providing drive power to an electric motor. The high voltage battery supplies necessary power through repeated charging and discharging while driving

A high-output lithium ion (polymer) battery (LiPB) is being widely used in hybrid electric vehicles as a high voltage battery. However, the LiPB system may have several limitations. When overcharging occurs in a battery cell, as shown FIG. 4, combustible gases may be generated due to exothermic decomposition of electrolyte. These gases may increase the internal pressure of the cell, leading to thickness expansion. Accordingly, since the temperature may increase and a short-circuit may occur, combustible gases may be ignited, causing significant danger to a driver and a vehicle. Particularly, in batteries for hybrid vehicles or fuel cell vehicles, since a plurality of batteries are modularized for a high voltage, there exists the danger of overcharging and ignition.

A conventional battery module may include a pouch type of lithium polymer battery module, electrode terminal parts of which are formed to be a vulnerable structure. This structure may prevent the outbreak of a fire due to overcharging by fracturing the electrode terminal when swelling.

However, the structure of the above mentioned battery module may induce fracturing of the electrode terminal part when overcharging occurs, in which the fracturing occurs in the entire electrode of a battery cell upon overcharging. Accordingly, once overcharging occurs, the battery pack must be replaced. When quantity of swelling is insufficient due to the manufacturing distribution of the battery pack, or welding is poorly executed, the fracturing may not occur to cause a safety issue.

The above information disclosed in this section is only for enhancement of understanding of the background of the invention and therefore it may contain information that does not form the prior art that is already known in this country to a person of ordinary skill in the art.

### SUMMARY OF THE DISCLOSURE

The present invention provides a safety apparatus for a battery module of an electric vehicle, eliminating the need to replace the entire battery pack by forming an opening in an end plate on which an expansive force of swelling is focused, installing a receptacle type power supply unit in the end plate, receiving the expansive force through the opening to interrupt current supplied to the battery module, and thus preventing the entire electrode of the cell from fracturing caused by typical swelling.

In one embodiment, the present invention provides a safety apparatus for a battery module of an electric vehicle, preventing an entire electrode of a battery cell from fracturing due to a swelling expansive force upon overcharging, the apparatus including: an end plate disposed at the ends of both sides of a battery module, having an opening, and delivering an expansive force generated in the battery module to the exterior through the opening upon swelling; and a power supply unit disposed in the end plate and configured to interrupt a current supplied to the battery module using the expansive force delivered through the opening.

In an exemplary embodiment, the power supply unit may include: a receptacle (e.g., a plug); a pair of fixing brackets disposed at both edges around the opening of the end plate; a pair of power lines having one end coupled to the fixing bracket, respectively; a fitting coupled to the other end of the power line by fitting and receiving the expansive force through the opening to separate the pair of power lines; and a wire connecting the power line to the battery module, and connecting the power line to a safety plug or a Power Relay Assembly (PRA).

In another exemplary embodiment, the power line may include a plate type of busbar.

### BRIEF DESCRIPTION OF THE DRAWINGS

The above and other features, objects and advantages of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view illustrating a safety apparatus for a battery module of an electric vehicle, according to an exemplary embodiment of the present invention;

FIG. 2 is an exemplary view illustrating a connection circuitry of a receptacle-type power supply unit in FIG. 1, according to an exemplary embodiment of the present invention;

FIG. 3 is an exemplary view illustrating current interruption upon swelling in the battery module in FIG. 1, according to an exemplary embodiment of the present invention; and

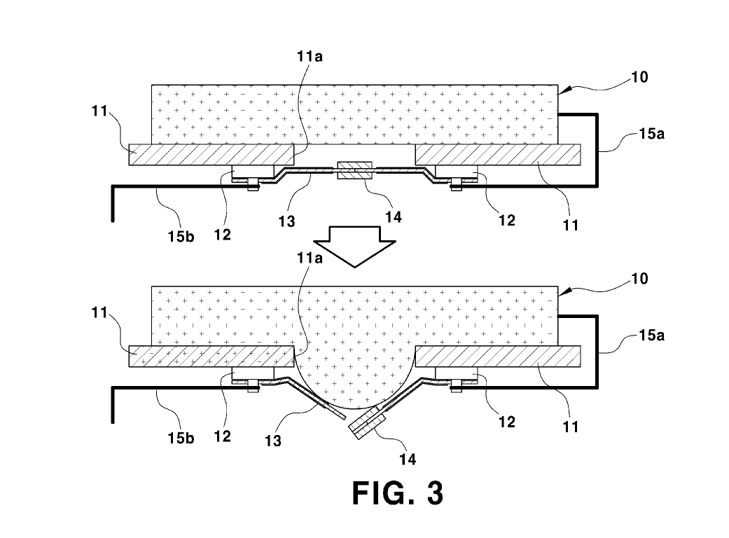

FIG. 4 is an exemplary image illustrating a battery cell before and after overcharging, according the related art.

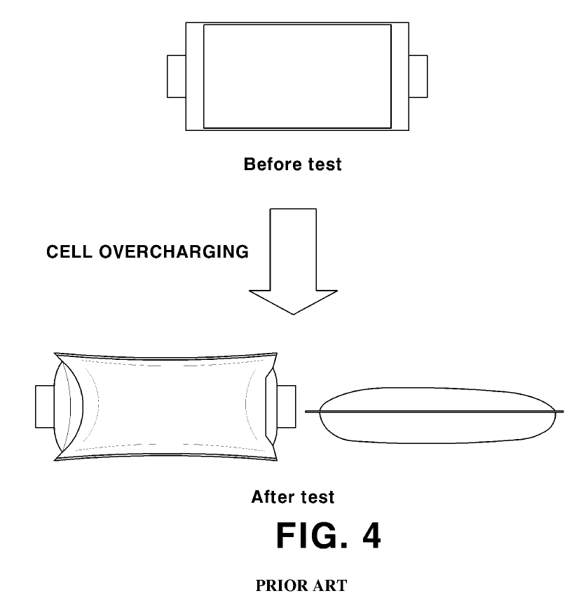

Reference numerals set forth in the Drawings includes reference to the following elements as further discussed below:

| | |
|---|---|
| 10: battery module | 11: end plate |
| 11a: opening | 12: fixing bracket |
| 13: power line | 14: fitting part |
| 15a: first wire | 15b: second wire |
| 16: safety plug | 17: PRA |
| 18: power supply unit | |

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings so that those skilled in the art can easily carry out the present invention.

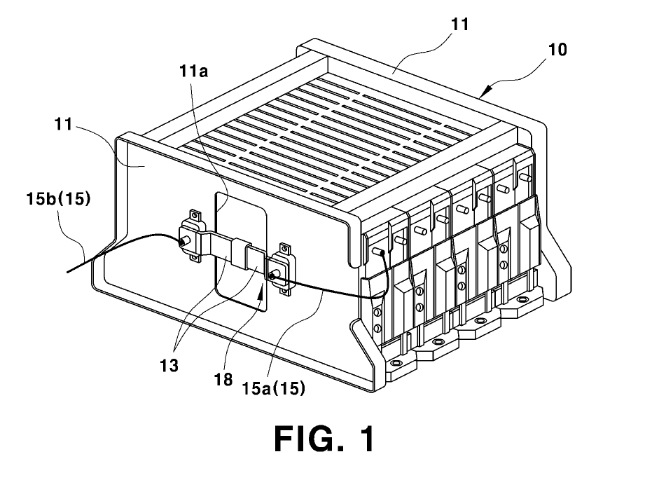

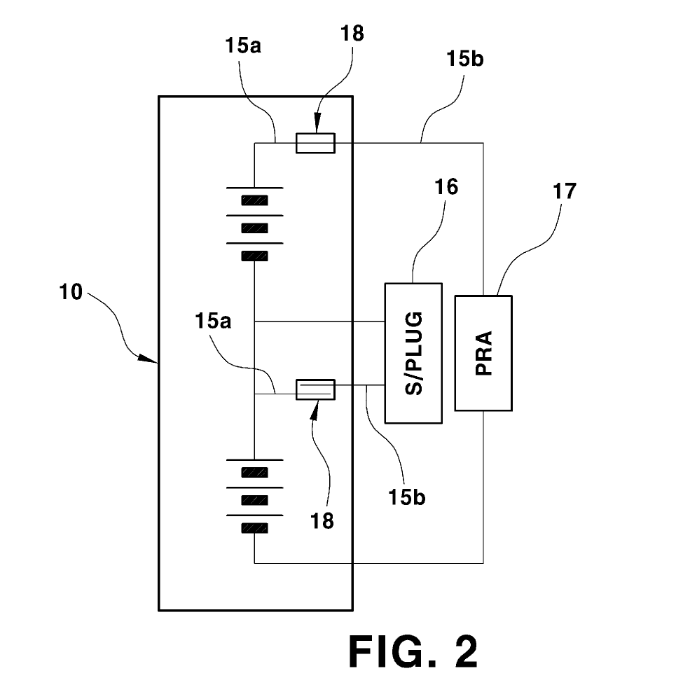

FIG. 1 is an exemplary view illustrating a safety apparatus for a battery module of an electric vehicle according to an exemplary embodiment of the present invention. FIG. 2 is an exemplary view illustrating a connection circuitry of a receptacle-type power supply unit in FIG. 1.

The present invention relates to a safety apparatus for a battery module of an electric vehicle, which may overcome limitations caused by overcharging without replacement of a battery pack by mechanically cutting off a wire when overcharging occurs.

In a safety apparatus for a battery module according to an exemplary embodiment of the present invention, a current may be interrupted by disposing a receptacle type power supply unit at a portion where a swelling force (e.g., expansive force) is applied and separating the power line (e.g., a busbar) 13 of the receptacle type power supply unit 18 using swelling generated by abnormal operation or overcharging of a battery pack.

A battery module 10 may include a plurality of battery cells disposed vertically adjacent to each other, and an end plate 11 that may be disposed at both ends across the plurality of battery cells.

When swelling occurs due to abnormal operation or overcharging of the battery pack, an expansive force of a pouch type battery case may be delivered to the end plate 11. To apply the expansive force toward the swelling, an opening 11a may be formed in the end plate 11.

The safety apparatus for the battery module may include end plates 11 of a battery module 10 having an opening formed therein, a receptacle (e.g., plug) type power connection unit configured to receive the expansive force of the battery case through the opening 11a, and a plurality of wires 15 connecting the power connection unit to the battery module 10 and a safety plug 16.

The end plates 11 may be disposed at the both side ends of the battery cells. The swelling expansive force generated from the battery cells may be delivered to the end plates 11 in the vertical direction of the battery cell (e.g., in a stacked direction of the battery cells or in the direction of crossing both end plates 11).

Particularly, the swelling expansive force may be applied to a middle portion of the battery cell. Accordingly, the expansive force of the battery module 10 may be delivered through the opening 11a formed in a middle portion of the end plate 11 on which the expansive force is concentrated.

The receptacle type power supply unit 18 may be formed to include a structure that may interrupt a current supplied to a battery module 10 using a swelling expansive force equal to or greater than a threshold value, generated from the battery module 10. The receptacle type power supply unit 18 may include a plurality of fixing brackets 12 respectively disposed on the same plane of both end plates 11 across the opening 11a, a plurality of power lines 13 coupled to the fixing bracket 12 by a bolt, respectively, and a fitting 14 for connecting the power lines 13.

The plurality of fixing brackets 12 may include a fixing body having a rectangular shape and a fixing rib vertically disposed between the upper and lower ends of the fixing body. The fixing rib may be coupled by a bolt to fix the fixing bracket 12 to the end plate 11. The fixing bolt may be attached to the fixing body to vertically protrude from a surface of the end plate 11. Each power line 13 may be a busbar formed of a plate type conductive material, having a longer length than the width thereof. A current may be delivered through the busbar.

A fixing hole may be formed in one end of the power line 13. Each power line 13 may be fixed to the fixing rib by connecting the fixing bolt of the fixing rib into the fixing hole. The other end of the power line may be coupled to the fitting 14 by a fitting method. The fitting 14 may be formed to have a shape of rectangular tube. The other end of both power lines 13 may be fitted into the fitting 14 by the half thereof.

The plurality of wires 15 may include a first wire 15a connecting the power line 13 to a battery cell disposed at the end of the battery module 10, and a second wire 15b connecting the power line 13 to the safety plug 16, or connecting the power line 13 to a Power Relay Assembly (PRA) 17.

Hereinafter, an operating state of a safety apparatus for a battery module of an electric vehicle according to an exemplary embodiment of the present invention will be described in detail.

When the battery module 10 operates normally or swelling caused by overcharging does not occur, the power of a vehicle may be delivered and charged into the battery module 10 through a receptacle type power supply unit 18 via the safety plug 16 or the PRA 17.

When the battery module 10 operates abnormally or the swelling caused by overcharging occurs, the battery case of the battery module 10 may swell through the opening 11a. Accordingly, the expansive force caused by the swelling may be delivered to the fitting 14 connecting the power line 13.

The fitting 14 may receive the expansive force in a vertical direction with respect to the surface of the end plate 11 of the battery module 10. In response to the fitting 14 receiving the expansion force, the power lines 13 fitted into the fitting part 14 may be separated from the fitting part 14 to allow the power lines 13 to be separated from each other, and thus a current supplied to the battery module 10 may be interrupted.

According to an embodiment of the present invention, the expansive force of the battery case generated from the battery module 10 may be delivered to the exterior by forming the opening 11a in the end plate 11, and the receptacle-type power supply unit 18 may interrupt a current supplied to the battery module 10 by receiving the expansive force from the battery module 10 and separating the power lines 13. Accordingly, since the entire electrode of the battery cell may be prevented from fracturing upon typical swelling, replacement the whole of the battery pack may be unnecessary. Additionally, since the receptacle type power supply unit 18 may be used as the safety apparatus for connecting and interrupting power to the battery module 10, the electric reliability and durability may be maintained.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A safety apparatus for a battery module of an electric vehicle, the apparatus comprising:
an end plate disposed at ends of both sides of a battery module, having an opening, wherein the battery module is configured to generate an expansive force delivered to an exterior through the opening upon swelling; and
a power supply unit disposed in the end plate, where in the power supply unit is configured to interrupt a current supplied to the battery module using the expansive force delivered through the opening.

2. The safety apparatus of claim 1, wherein the power supply unit comprises a receptacle type.

3. The safety apparatus of claim 1, wherein the power supply unit comprises:
a pair of fixing brackets disposed at both edges around the opening of the end plate;
a pair of power lines having one end coupled to the pair of fixing brackets, respectively;
a fitting coupled to the other end of the power line by a fitting method; and
a wire connecting the power line to the battery module and to a safety plug or a Power Relay Assembly.

4. The safety apparatus of claim 3, wherein the power line end coupled to the fitting is configured to release from the fitting, separating the pair of power lines, in response to a pressure from the expansive force against the opening.

5. The safety apparatus of claim 3, wherein the power line comprises a plate type of busbar.
